(19) United States
(12) Patent Application Publication
(10) Pub. No.: US 2015/0091792 A1
(43) Pub. Date: Apr. 2, 2015

(54) DISPLAY APPARATUS AND CONTROL METHOD THEREOF

(71) Applicant: SAMSUNG ELECTRONICS CO., LTD., Suwon-si (KR)

(72) Inventor: Gang-mo KOO, Suwon-si (KR)

(73) Assignee: SAMSUNG ELECTRONICS CO., LTD., Suwon-si (KR)

(21) Appl. No.: 14/314,615

(22) Filed: Jun. 25, 2014

(30) Foreign Application Priority Data
Oct. 2, 2013 (KR) 10-2013-0118074

(51) Int. Cl. G06F 3/01; G09G 5/10

(52) U.S. Cl. CPC G06F 3/01; G09G 5/10
USPC 345/156

(57) ABSTRACT

Apparatuses and methods related to a display apparatus and a control method thereof, are provided. More particularly, the apparatuses and methods relate to a display apparatus and a control method thereof, in which brightness of an area of a screen is adjusted in consideration of an external light source reflected on the screen.

### CROSS-REFERENCE TO RELATED APPLICATION

This application claims priority from Korean Patent Application No. 10-2013-0118074, filed on Oct. 2, 2013 in the Korean Intellectual Property Office, the disclosure of which is incorporated herein by reference.

### BACKGROUND

1. Field

Apparatuses and methods consistent with exemplary embodiments relate to a display apparatus and a control method thereof, and more particularly, to a display apparatus and a control method thereof, in which the brightness of a screen is adjusted in consideration of an external light source reflected on the screen.

2. Description of the Related Art

With development of technology, a television (TV), a monitor, a portable terminal and/or other similar display apparatuses now support various functions such as Web surfing, games, photographing of a still image or a moving image, etc. as well as a basic function of displaying an image. In particular, functions such as photographing, video calling, games, etc. are available in a display apparatus with a detachable camera or a built-in camera.

Besides the foregoing functions, the camera provided in the display apparatus senses ambient light of the display apparatus in order to adjust the brightness of an image displayed on a display. For example, if the ambient light of the display apparatus is bright, the image displayed on the display may be brightened so that a viewer can view a more vivid image. On the other hand, if there is little ambient light, the image displayed on the display may be dimmed so that power consumption of the display apparatus can be reduced to conserve energy.

However, if a fluorescent lamp, a desk lamp, the sun and/or other external light source are regularly reflected from a screen of the display, that is, if the external light source appears on the screen, an image on the screen may be blurred. In this case, the display apparatus with the foregoing function takes only its ambient brightness into account without considering the light of the external light source reflected from a certain region of the screen of the display in order to adjust the brightness of the entire image displayed on the display. This reflected light appears at the certain region of the screen in accordance with a viewing position of a user, and thus obscures the image displayed at that region, thereby deteriorating visibility. Further, if the intensity of light from the external light source is very strong, a user may be dazzled by the reflected light. To address this problem, a user has to inconveniently and manually adjust the brightness or change the settings of the image displayed on the display.

### SUMMARY

One or more exemplary embodiments provide a display apparatus and a control method thereof, in which reflection of an external light source from a screen of a display is taken into account to adjust a setting of an image in a certain region on the screen, thereby improving visibility of a user.

According to an aspect of an exemplary embodiment, there is provided a display apparatus including: a display which comprises a screen for displaying an image thereon; a camera which captures an image of a region in front of the display; and a controller which determines a reflection region of the screen where a degree of reflecting light of an external light source at a viewing position of a user is greater than or equal to a predetermined value based on the image of the region in front of the display, and controls a brightness of the image in the reflection region of the screen to be greater than a brightness of the image in another region of the screen.

The controller may be configured to determine the reflection region by measuring a distance between the user and the display based on the image of the region in front of the display.

The controller may be configured to control a contrast value of the image in the reflection region of the screen to be greater than a contrast value of the image in the other region of the screen.

The controller may be configured to control an edge enhancement value of the image in the reflection region of the screen to be greater than an edge enhancement value of the image in the other region of the screen.

The camera may be configured to measure an intensity of light emitted from the external light source, and the controller may be configured to control a brightness of the image in the reflection region of the screen in accordance with the measured intensity of the light.

The controller may be configured to control a contrast value of the image in the reflection region of the screen to be greater than a contrast value of the image in the other region of the screen if the measured intensity of light is greater than or equal to a predetermined value.

The controller may be configured to control an edge enhancement value of the image in the reflection region of the screen to be greater than an edge enhancement value of the image in the other region of the screen if the measured intensity of light is greater than or equal to a predetermined value.

The controller may be configured to control brightness of an entire area of the image of the screen to be greater than a brightness of a setup image if both the user and the external light source are reflected on the image of the region in front of the display.

According to an aspect of another exemplary embodiment, there is provided a method of controlling a display apparatus comprising: capturing an image of a region in front of a display by using a camera; determining a reflection region of a screen of the display where a degree of reflecting light of an external light source at a viewing position of a user is greater than or equal to a predetermined value based on the image of the region in the front of the display; and controlling a brightness of the image in the reflection region of the screen to be greater than a brightness of the image in another region of the screen.

The determining the reflection region of the screen may comprise: measuring a distance between the user and the display based on the image of the region in front of the display; and determining the reflection region of the screen based on the measured distance.

The method may be provided further comprising: controlling a contrast value of the image in the reflection region of the screen to be greater than a contrast value of the image in the other region of the screen.

The method may be provided further comprising: controlling an edge enhancement value of the image in the reflection region of the screen to be greater than an edge enhancement value of the image in the other region of the screen.

The method may be provided further comprising: measuring intensity of light emitted from the external light source by using the camera; and controlling a brightness of the image in the reflection region of the screen in accordance with the measured intensity of the light.

The method may be provided further comprising: controlling a contrast value of the image in the reflection region of the screen to be greater than a contrast value of the image in the other region of the screen if the measured intensity of the light is greater than or equal to a predetermined value.

The method may be provided further comprising: controlling an edge enhancement value of the image in the reflection region of the screen to be greater than an edge enhancement value of the image in the other region of the screen if the measured intensity of the light is greater than or equal to a predetermined value.

The method may be provided further comprising: controlling a brightness of an entire area of the image of the screen to be greater than a brightness of a setup image if both the user and the external light source are reflected on the image of the region in front of the display.

According to an aspect of another exemplary embodiment, there is provided a non-transitory computer readable medium comprising computer executable instructions that cause a computer to perform: capturing an image of an area in front of a display; determining a region of the display where a light reflected by the display at a viewing position of a user is greater than or equal to a predetermined value based on the captured image; and increasing a brightness of the determined region of the display to be greater than a brightness of another region of the display.

The non-transitory computer readable medium may further include computer executable instructions that cause the computer to perform: measuring a distance between the user and the display using the captured image. The region of the display where the light reflected by the display at the viewing position of the user is greater than or equal to the predetermined value may be determined based on the measured distance.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram schematically showing a display apparatus according to an exemplary embodiment;

FIG. 2 illustrates a use state schematically showing a display apparatus according to an exemplary embodiment;

FIGS. 3 to 6 schematically show methods of determining a reflection region in the display apparatus according to exemplary embodiments; and

FIGS. 7 and 8 are schematic flowcharts of controlling the display apparatus according to exemplary embodiments.

### DETAILED DESCRIPTION OF EXEMPLARY EMBODIMENTS

Below, a display apparatus and a control method thereof according to exemplary embodiments will be described in detail with reference to accompanying drawings.

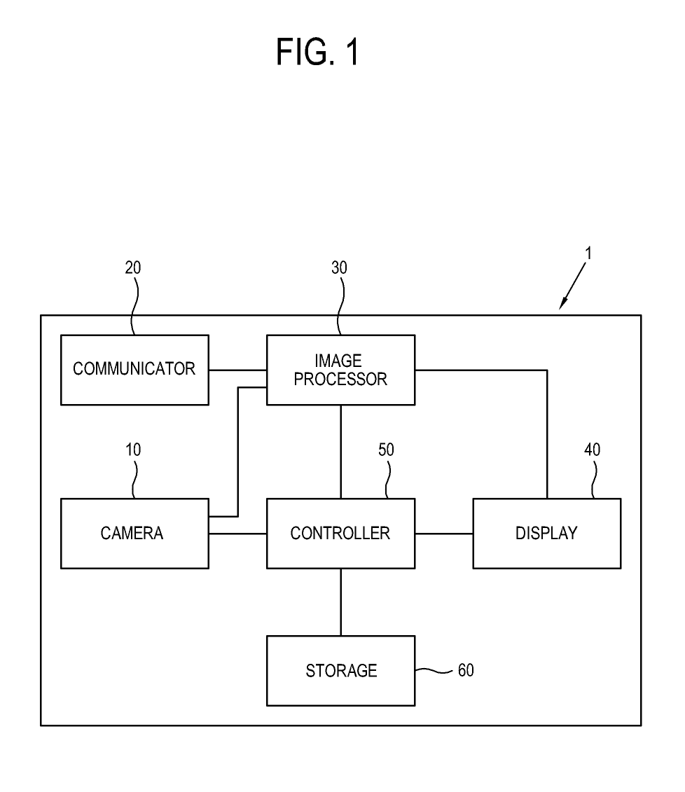

FIG. 1 is a block diagram schematically showing a display apparatus 1 according to an exemplary embodiment;

As shown in FIG. 1, a display apparatus 1 in this exemplary embodiment includes a camera 10 which photographs or captures a moving image/a still image of an external environment, a communicator 20 which transmits and receives data or the like to and from an exterior, an image processor 30 which processes an image signal to display a received image, a display 40 which displays an image, a controller 50 which controls operations of the display apparatus 1, and a storage 60 which stores predetermined data.

In this exemplary embodiment, the display apparatus may include any device, which can process an image signal/image data and display it, such as a TV, a monitor for a computer, a portable multimedia player, a mobile phone, etc. to which the camera 10 is detachably connected or internally provided. However, the exemplary embodiments are not limited thereto.

The camera 10 may be detachably connected to or internally provided in the display apparatus 1. Further, the camera 10 senses and photographs external environments of the display apparatus 1.

The camera 10 may monitor the external environments for a predetermined period of time or at predetermined time intervals, and acquire an image by photographing a front region of the display 40 (hereinafter, referred to as a ‘photographed image’). For example, if it is sensed that a user and an external light source are located in front of the display apparatus 1, the camera 10 informs the controller 50 that the user and the external light source are sensed, and photographs the sensed user and external light source, thereby transmitting the photographed image to the controller 50. Also, the camera 10 senses an intensity of light from the external light source and transmits it to the controller 50.

The communicator 20 may not only include elements for receiving a signal/data from an external input, but also further include various additional elements such as a wireless communication module (not shown) for wireless communication, a tuner (not shown) for tuning to a broadcasting signal, etc. in accordance with designs of the display apparatus 1. In addition to receiving a signal from an external device, the communicator 20 may transmit information/data/signals of an image processing apparatus to the external device. That is, the communicator 20 is not limited to receiving a signal from the external device, and may be an interface for interactive communication. Further, the communicator 20 may include a communication module for short range wireless communication such as Bluetooth, infrared (IR), ultra wideband (UWB), Zigbee, etc., and may further include a communication port for wired communication.

The communicator 20 may transmit image data photographed by the camera 10 to the controller 50, and send a command signal for controlling the camera 10 from the controller 50 to the camera 10, if the camera 10 is detachably provided in the display apparatus 1.

The image processor 30 processes an image signal, received through the communicator 20, to be displayed as an image. The image processor 30 may perform demodulation, analog-to-digital (A/D) conversion, decoding, de-multiplexing, etc. in order to extract an image from the image signal. Also, the image processor 30 may perform scaling so that an image can be displayed with a predetermined size on the display 40; adjustment of characteristics such as brightness, color, contrast, etc. of an image; and various image enhancement processes for enhancing quality of an image.

The image processor 30 applies various imaging processes previously set up with regard to a source image which includes a broadcasting signal and an image signal received from an image source (not shown), such as an image signal received from the communicator 20, an image signal photographed by the camera 10, and an image signal stored in the storage 60. The image processor 30 outputs the image signal subjected to such processes to the display 40 so that a processed source image can be displayed on the display 40.

The display 40 may display an image based on an image signal output from the image processor 30. There is no limit to the type of the display 40. For example, the display may be one of various types of displays such as liquid crystal, plasma, a light-emitting diode, an organic light-emitting diode, a carbon nano-tube, nano-crystal, etc.

The display 40 may include an additional element in accordance with its type. For example, if the display 40 is achieved by the liquid crystal, the display 40 may include a liquid crystal display panel (not shown), a backlight unit (not shown) emitting light to the display panel, and a panel driving substrate (not shown) for driving the display panel.

Further, the display 40 displays an image of an external environment photographed by the camera 10, so that a user can check it.

The storage 60 is provided as a nonvolatile memory (i.e., writable read only memory (ROM)) such as a flash memory, a hard disk drive, etc., and stores information and a program needed for operating the display apparatus 1. The information needed for operating the display apparatus 1 may include all the information to be referred to while performing various functions, for example, information display, brightness control for an image, volume control, etc. The display apparatus 1 performs operations by executing a program stored in the storage 60. Here, the program includes an operating system (OS), an application program, etc.

The storage 60 stores data about a face size, a distance between eyes, etc. of an average human. This data will be used in calculating an actual distance between the display apparatus 1 and a user by measuring a human's face size or the like within an image photographed by the camera 10.

The controller 50 generally controls the display apparatus 1. The controller 50 may include a control program, a nonvolatile memory such as a flash memory or the like for storing the control program, a volatile memory such as a random access memory for loading at least a part of the control program, a microprocessor for executing the loaded control program.

The controller 50 receives a photographed image involving a user and an external light source located in front of the display 40 from the camera 10; determines a reflection region from which light of the external light source is reflected with respect to a viewing position of the user within the region of the screen on the display 40, based on the photographed image; and controls the brightness of the image in the reflection region of the screen to be greater than the brightness of the image in the other region.

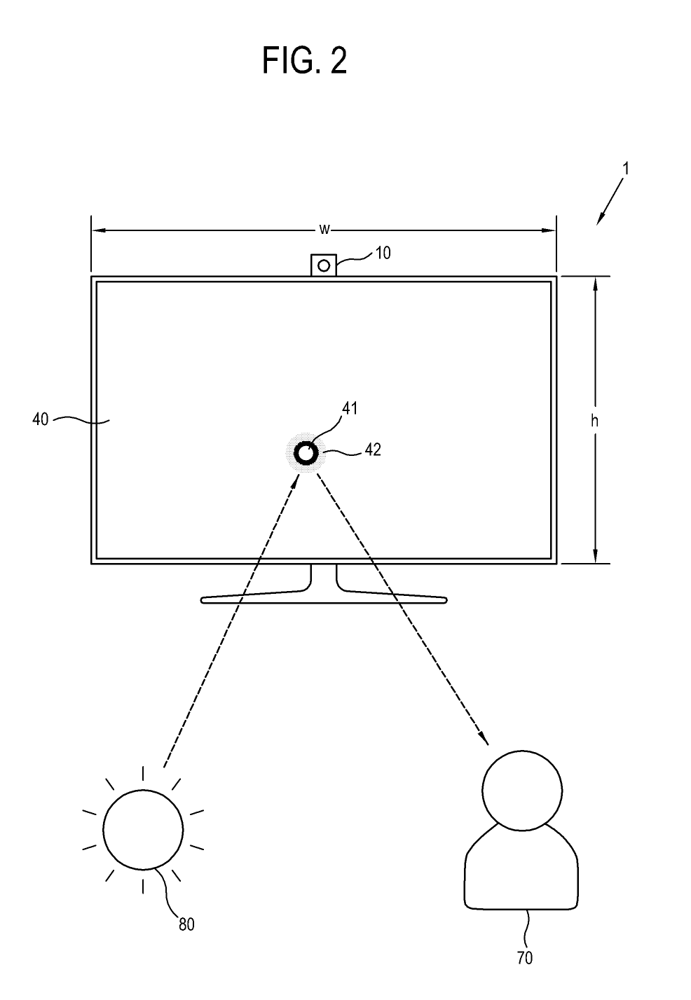

FIG. 2 illustrates a use state schematically showing the display apparatus 1 according to an exemplary embodiment.

Referring to FIG. 2, a user 70 is located at a right side and an external light source 80 is located at a left side in front of the display apparatus 1. Here, the external light source 80 may be any light source that can emit light, such as a lighting device, the sun, etc. If the display 40 is viewed at the location of the user 70, the light emitted from the external light source 80 is regularly reflected from the screen of the display 40 and appears in the screen of the display 40. At this time, the user 70 views an external light source 41 reflected in a reflection region 42 of the screen on the display 40. Like this, if an image is displayed in the screen on the display 40, the image in the reflection region where external light is regularly reflected from the screen is more blurred than the image in the other region, thereby deteriorating visibility.

To solve the foregoing problems, the camera 10 placed in an upper portion of the display apparatus 1 according to an exemplary embodiment photographs the user 70 and the external light source 80 located in front of the display apparatus 1 and transmits the photographed image to the controller 50. Then, the controller 50 measures a distance between the display 40 and the user 70 based on the photographed image, determines a position of the reflection region 42 where the external light source 80 is reflected in the screen on the display 40 based on the measured distance, and controls the brightness of the reflection region 42 to be greater than the brightness of the other region, thereby preventing the visibility from being deteriorated.

Below, a method of determining the reflection region 42 from which the external light source 80 is reflected in the screen on the display 40 will be described in more detail.

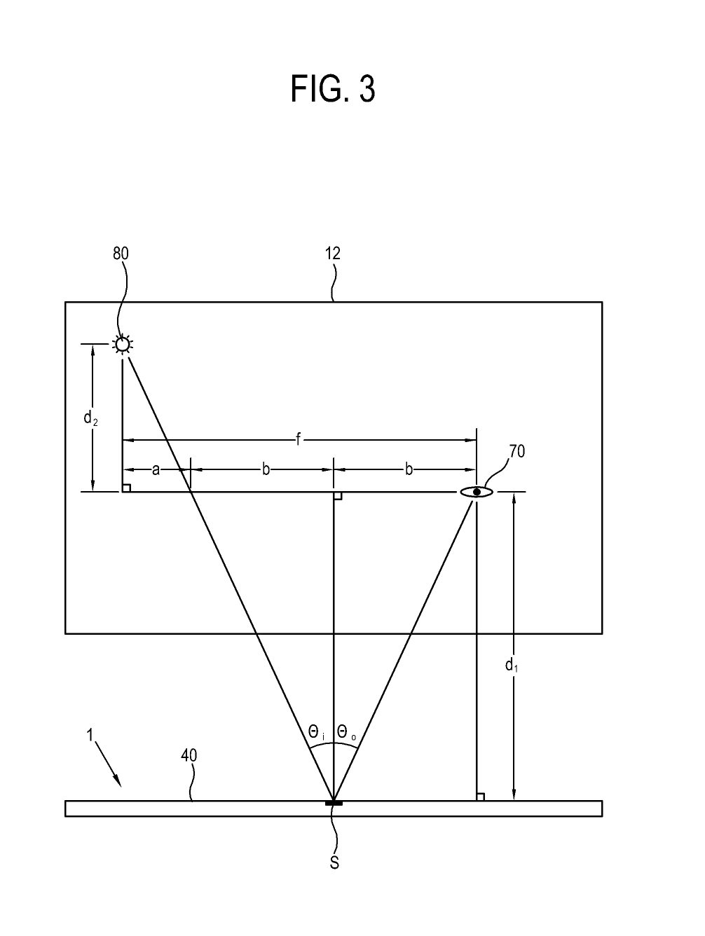

FIGS. 3 to 6 schematically show methods of calculating a position of a reflection region S in the display 40 apparatus according to exemplary embodiments.

First, the user 70 and the external light source 80 located in front of the display apparatus 1 are photographed by the camera 10 provided in the display apparatus 1. Further, the camera 10 transmits the photographed image 12 to the controller 50.

The controller 50 measures a face size, a distance between eyes, etc. of a user within the photographed image 12 and compares them with data about a face size, a distance between eyes, etc. of an average human stored in the storage 60, thereby calculating a distance d₁ between the display 40 and the user 70.

Further, the controller 50 calculates a horizontal distance f and a vertical distance d2 from the user 70 to the external light source 80, based on the calculated distance d₁ between the display 40 and the user 70. Here, an incident angle θᵢ of incident light emitted from the external light source 80 to the display 40 is equal to a reflective angle θ, of reflecting light reflected from the display 40 to the user 70. Thus, if the incident angle θᵢ is obtained, it is possible to calculate a horizontal distance b between the user 70 and the reflection region S, thereby determining the position of the reflection region S on the display 40.

In more detail, referring to FIG. 3, d₁, d₂ and f are constant values because they can be obtained by the controller through the photographed image 12; a is obtained from d₂·tan θ₁; and b is obtained from d₁·tan θₒ. Here, a+2b is f and θᵢ is equal to θₒ, and therefore θᵢ is tan⁻¹(f/(2d₁+d₂)). Thus, it is possible to obtain θᵢ by substituting d₁, d₂ and f obtained as above.

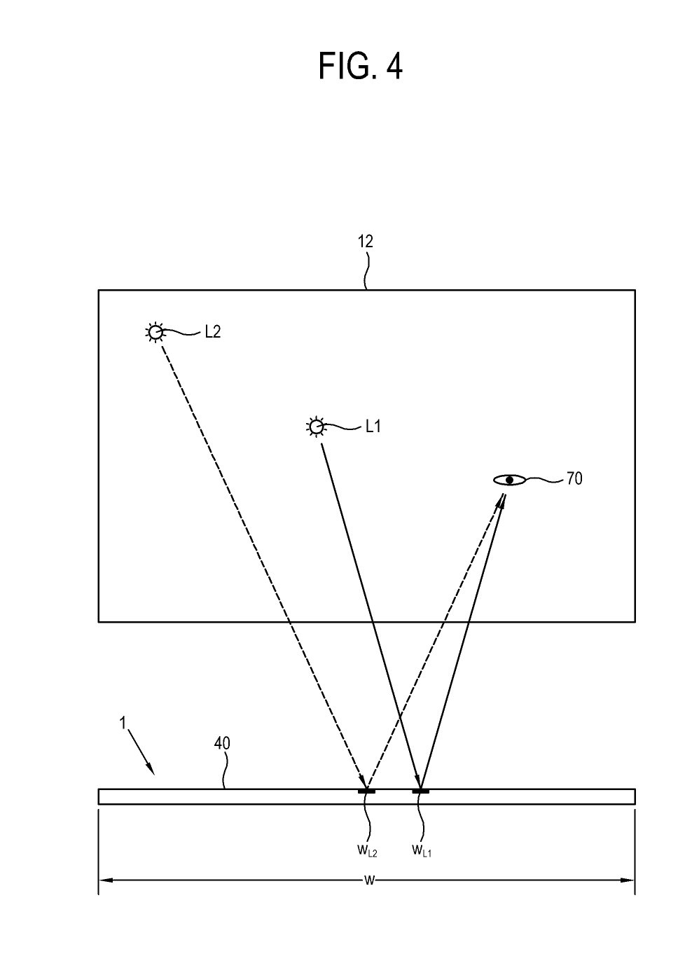

FIGS. 4 to 6 are views for determining the reflection region S by calculating a horizontal position and a vertical position of the reflection region S on the display 40 through the foregoing calculating method.

FIG. 4 shows an example that horizontal positions w_{L1} and w_{L2} of the reflection regions due to two external light sources L1 and L2 in the display apparatus 1 are obtained based on the photographed image 12 of the user 70 and the external light sources L1 and L2 located in front of the display apparatus 1.

To obtain the horizontal positions w_{L1} and w_{L2} of the reflection region, a horizontal direction of the photographed image 12 is arranged to be in parallel with a width direction w of the display apparatus 1, and a horizontal directional center of the photographed image 12 is aligned with a width directional center of the display apparatus 1. Further, if the position of the reflection region is calculated through the method shown in FIG. 3, at the location of the user 70, the horizontal position of the reflection region where the first external light source L1 is reflected in the display apparatus 1 is w_{L1}, and the horizontal position of the reflection region where the second external light source L2 is reflected in the display apparatus 1 is w_{L2}.

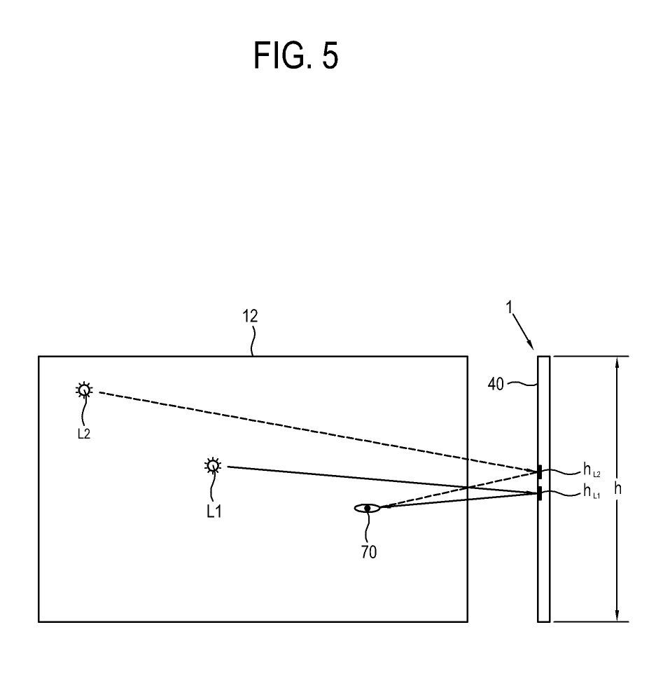

FIG. 5 shows an example that vertical positions h_{L1} and h_{L2} of the reflection regions due to two external light sources L1 and L2 in the display apparatus 1 are obtained based on the photographed image 12 of the user 70 and the external light sources L1 and L2 located in front of the display apparatus 1.

To obtain the vertical positions h_{L1} and h_{L2} of the reflection region, a vertical direction of the photographed image 12 is arranged to be in parallel with a height direction h of the display apparatus 1, and a vertical directional center of the photographed image 12 is aligned with a height directional center of the display apparatus 1. Further, if the position of the reflection region is calculated through the method shown in FIG. 3, at the location of the user 70, the vertical position of the reflection region where the first external light source L1 is reflected in the display apparatus is h_{L1}, and the vertical position of the reflection region where the second external light source L2 is reflected in the display apparatus 1 is h_{L2}.

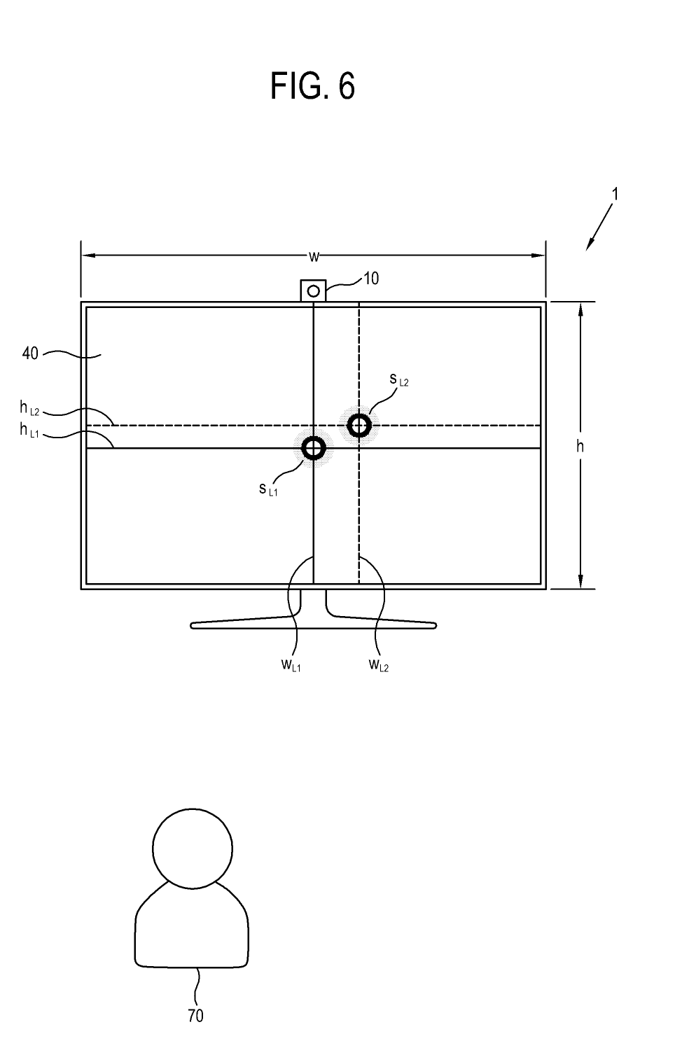

FIG. 6 shows the reflection region on the display 40, based on the horizontal position of the reflection region obtained as shown in FIG. 4 and the vertical position of the reflection region obtained as shown in FIG. 5. When the display 40 is viewed at the location of the user 40, the reflection region where the first external light source L1 is reflected in the display 40 is S_{L1} where the line w_{L1} corresponding to the horizontal position intersects the line h_{L1} corresponding to the vertical position, and the reflection region where the second external light source L2 is reflected in the display 40 is S_{L2} where the line w_{L2} corresponding to the horizontal position intersects the line h_{L2} corresponding to the vertical position.

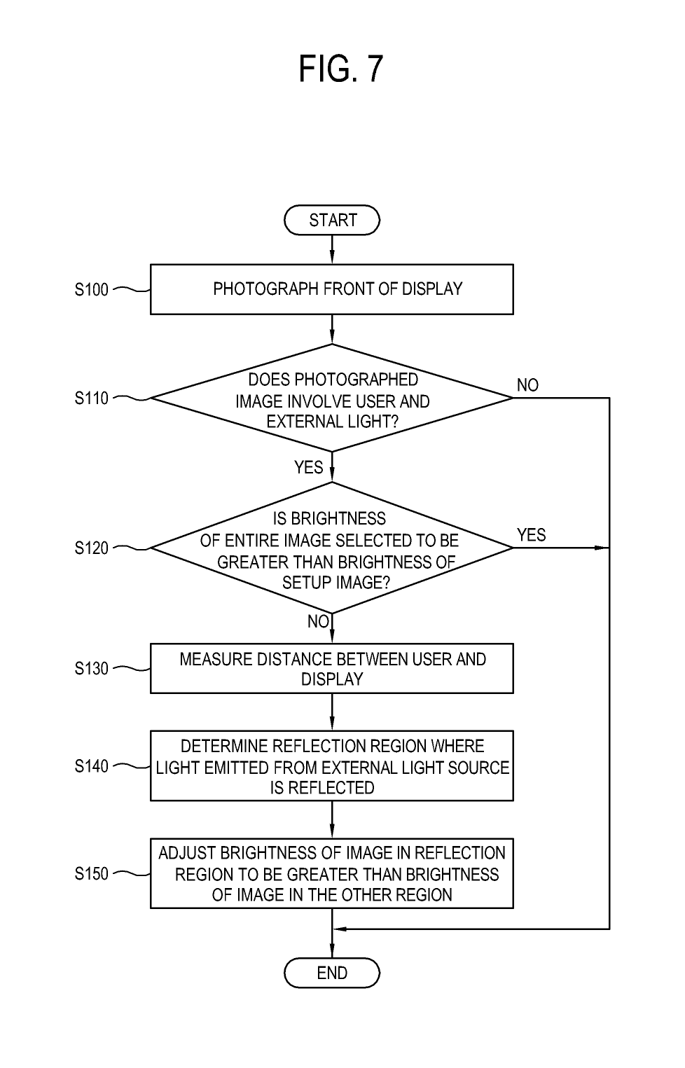

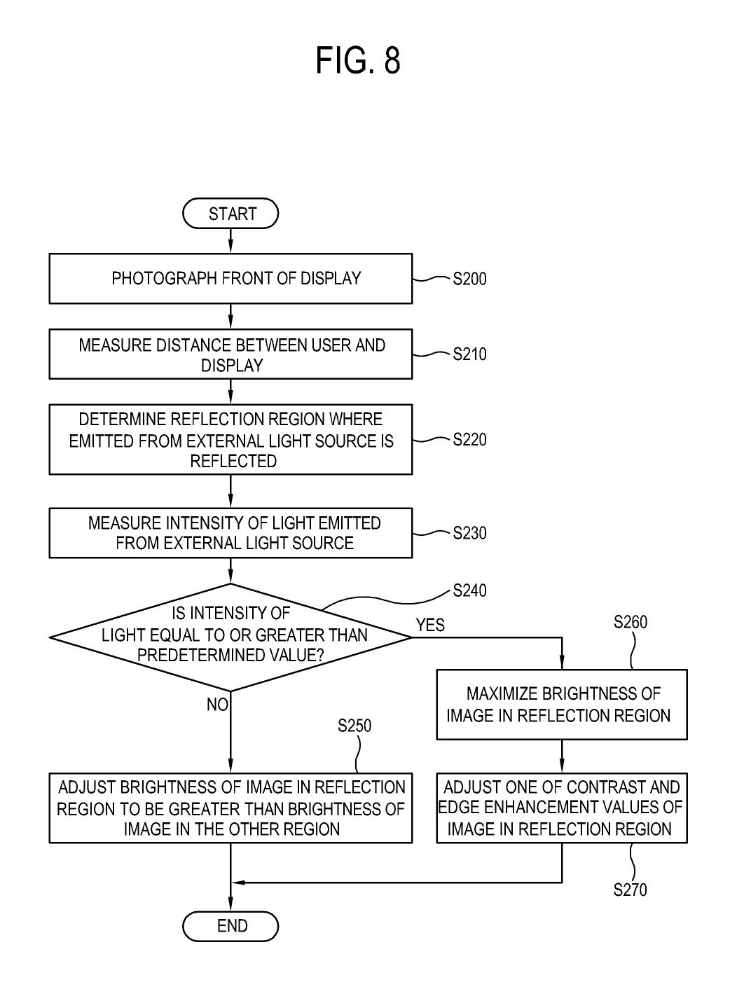

FIGS. 7 and 8 are schematic flowcharts of controlling the display apparatus according to exemplary embodiments.

Referring to FIG. 7, a method of controlling the display apparatus 1 according to an exemplary embodiment includes photographing a front of the display 40 through the camera 10 (S100), determining whether a user and external lighting are present in the photographed image (S110), and selecting whether to control the brightness of the entire image to be greater than the brightness of a setup image (S120) if the user and the external lighting are present in the photographed image (YES of S110). If the user selects the brightness of the entire image to be greater than the brightness of the setup image (YES of S120), the controller 50 controls the brightness of the screen on the display 40 to become brighter than the currently setup brightness. On the other hand, if the user selects the brightness of the entire image not to be greater than the brightness of the setup image (No of S120), the controller 50 measures a distance between the display 40 and the user (S130). After the distance between the display 40 and the user is measured (S130), the controller 50 determines the reflection region, from which light emitted from the external light source is regularly reflected in the screen of the display 40, through the calculation method shown in FIG. 3 (S140). Further, the controller 50 adjusts the brightness of the image in the reflection region where the external light source is reflected in the screen of the display 40 to be greater than the brightness of the image in the other region (S150), thereby improving visibility. Also, the controller 50 determines whether the photographed image taken by the camera 10 photographing a front of the display 40 involves the user and the external light (S100), and does not control the brightness of the screen on the display 40 if the photographed image does not involve the user and the external light (No of S110).

Referring to FIG. 8, in a method of controlling the display apparatus 1 according to another exemplary embodiment, the camera 10 photographs a front of the display 40 (S200), and the controller 50 measures a distance between a user and the display 40 if the photographed image involves the user and external light (S210). When the distance between the display and the user is measured (S210), the controller 50 determines the reflection region where light emitted from the external light source is regularly reflected from the screen of the display 40, based on the measured distance through the calculating method shown in FIG. 3 (S220). Further, the camera measures the intensity of the light emitted from the external light source (S230), and the controller 50 controls the brightness of the image in the reflection region where the external light source is reflected in the screen of the display 40 to be greater than the brightness of the image in the other region (S250) if the measured intensity of the light is less than or equal to a predetermined value (NO of S240). On the other hand, if the measured intensity of the light is greater than or equal to a predetermined value (YES of S240), the controller 50 maximizes the brightness of the image in the reflection region where the external light source is reflected in the screen of the display 40 (S260), and adjusts one of a contrast value and an edge enhancement value of the image in the reflection region (S270). The amount of the brightness adjustment of the image in the reflection region may be adjusted or may vary according to the measured intensity of the light emitted from the external light source. This is to improve visibility by increasing the contract value or the edge enhancement value or by increasing both the contract value and the edge enhancement value when the intensity of the light from the external light source is so strong that the visibility is deteriorated even though the brightness of the image in the reflection region is maximized.

In the display apparatus and the control method according to an exemplary embodiment, the brightness of an image in a region where an external light source is reflected in a screen of the display is controlled to be greater than the brightness of an image in the other region, thereby having an effect on improving a user's visibility.

Further, it is possible to increase the brightness of an image only in a certain region where an external light source is reflected in a screen of the display, thereby having an effect on reducing power consumption in the display apparatus as compared with that of when the brightness of the image of the entire screen region is increased.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. A display apparatus comprising:
a display comprising a screen which is configured to display an image;
a camera which is configured to capture an image of a region in front of the display; and
a controller which is configured to determine a reflection region of the screen where a degree of reflecting light of an external light source at a viewing position of a user is greater than or equal to a predetermined value based on the image of the region in front of the display, and control a brightness of the image in the reflection region of the screen to be greater than a brightness of the image in another region of the screen.

2. The display apparatus according to claim 1, wherein the controller is configured to determine the reflection region by measuring a distance between the user and the display based on the image of the region in front of the display.

3. The display apparatus according to claim 1, wherein the controller is configured to control a contrast value of the image in the reflection region of the screen to be greater than a contrast value of the image in the other region of the screen.

4. The display apparatus according to claim 1, wherein the controller is configured to control an edge enhancement value of the image in the reflection region of the screen to be greater than an edge enhancement value of the image in the other region of the screen.

5. The display apparatus according to claim 1, wherein the camera is configured to measure an intensity of light emitted from the external light source, and
the controller is configured to control a brightness of the image in the reflection region of the screen in accordance with the measured intensity of the light.

6. The display apparatus according to claim 5, wherein the controller is configured to control a contrast value of the image in the reflection region of the screen to be greater than a contrast value of the image in the other region of the screen if the measured intensity of the light is greater than or equal to a predetermined value.

7. The display apparatus according to claim 5, wherein the controller is configured to control an edge enhancement value of the image in the reflection region of the screen to be greater than an edge enhancement value of the image in the other region of the screen if the measured intensity of the light is greater than or equal to a predetermined value.

8. The display apparatus according to claim 1, wherein the controller is configured to control a brightness of an entire area of the image of the screen to be greater than a brightness of a setup image if both the user and the external light source are reflected on the image of the region in front of the display.

9. A method of controlling a display apparatus, the method comprising:
capturing an image of a region in front of a display by using a camera;
determining a reflection region of a screen of the display where a degree of reflecting light of an external light source at a viewing position of a user is greater than or equal to a predetermined value based on the image of the region in the front of the display; and
controlling a brightness of an image in the reflection region of the screen to be greater than a brightness of the image in another region of the screen.

10. The method according to claim 9, wherein the determining the reflection region of the screen comprises:
measuring a distance between the user and the display based on the image of region in front of the display; and
determining the reflection region of the screen based on the measured distance.

11. The method according to claim 9, further comprising controlling a contrast value of the image in the reflection region of the screen to be greater than a contrast value of the image in the other region of the screen.

12. The method according to claim 9, further comprising: controlling an edge enhancement value of the image in the reflection region of the screen to be greater than an edge enhancement value of the image in the other region of the screen.

13. The method according to claim 9, further comprising:
measuring intensity of light emitted from the external light source by using the camera; and
controlling a brightness of the image in the reflection region of the screen in accordance with the measured intensity of the light.

14. The method according to claim 13, further comprising: controlling a contrast value of the image in the reflection region of the screen to be greater than a contrast value of the image in the other region of the screen if the measured intensity of the light is greater than or equal to a predetermined value.

15. The method according to claim 13, further comprising: controlling an edge enhancement value of the image in the reflection region of the screen to be greater than an edge enhancement value of the image in the other region of the screen if the measured intensity of the light is greater than or equal to a predetermined value.

16. The method according to claim 9, further comprising: controlling a brightness of an entire area of the image of the screen to be greater than a brightness of a setup image if both the user and the external light source are reflected on the image of the region in front of the display.

17. A non-transitory computer readable medium comprising computer executable instructions that cause a computer to perform:
capturing an image of an area in front of a display;
determining a region of the display where a light reflected by the display at a viewing position of a user is greater than or equal to a predetermined value based on the captured image; and
increasing a brightness of the determined region of the display to be greater than a brightness of another region of the display.

18. The non-transitory computer readable medium of claim 17, further comprising computer executable instructions that cause the computer to perform:
measuring a distance between the user and the display using the captured image,
wherein the region of the display where the light reflected by the display at the viewing position of the user is greater than or equal to the predetermined value is determined based on the measured distance.
